(19) United States
(12) Patent Application Publication
(10) Pub. No.: US 2016/0054686 A1
(43) Pub. Date: Feb. 25, 2016

(54) IMAGE FORMING APPARATUS

(71) Applicant: KYOCERA Document Solutions Inc., Osaka (JP)

(72) Inventors: Rei YAMAGISHI, Osaka (JP); Mitsuhiro TAHARA, Osaka (JP)

(73) Assignee: KYOCERA Document Solutions Inc., Osaka (JP)

(21) Appl. No.: 14/814,867

(22) Filed: Jul. 31, 2015

(30) Foreign Application Priority Data
Aug. 25, 2014 (JP) 2014-170303

(51) Int. Cl. G03G 15/00

(52) U.S. Cl. CPC G03G 15/2028

(57) ABSTRACT

An image forming apparatus includes: an image forming section; a fixing portion; a discharging portion; a sheet transport passage including a curved portion and connecting between the fixing portion and the discharging portion; a reverse transport passage formed by branching off the curved portion; a transport roller pair rotatable in normal and reverse directions; a fixed guide portion provided on an inner corner side of the curved portion; and a swingable guide portion supported to be swingable. The swingable guide portion is arranged selectively either in a first position where it protrudes farther into the sheet transport passage than a guide rib formed on a transport surface of the fixed guide portion or a second position where its protruding height from the transport surface is equal to a height of the guide rib or where the swingable guide portion is retracted farther toward the transport surface than the guide rib.

### INCORPORATION BY REFERENCE

This application is based upon and claims the benefit of priority from the corresponding Japanese Patent Application No. 2014-170303 filed on Aug. 25, 2014, the entire contents of which are incorporated herein by reference.

### BACKGROUND

The present disclosure relates to an image forming apparatus, such as a copier, a facsimile machine and a printer, that is provided with a double-sided printing function for printing on both sides of a sheet.

Some known conventional image forming apparatuses have a double-sided printing function whereby, after an image is printed on one side of paper (a sheet), the paper is transported again to an image forming section with the printed side reversed so that an image is printed also on the other side of the paper on which no image has yet been printed.

According to one method of reversing a printed side of paper, a reverse transport passage (double-side transport passage) is provided which branches off the transport passage used for regular printing. After a tail end of paper has passed through a branching portion, the transport direction is reversed; thus the paper then enters, starting with its tail end, the double-side transport passage (to perform a switchback) and has the printed side reversed.

A known color printer is provided with a transport-in passage through which paper is received from a double-side transport passage, a reversal passage which is connected to the transport-in passage and in which the paper is reversed, and a transport-out passage through which the reversed paper is transported back toward a registration roller pair. In such color printers, a reversal switching claw is provided in a joining portion (branching portion) between the transport-in passage and the transport-out passage, and when the paper is transported in, the transport-in passage side of the reversal passage is opened, and when the paper is transported out, the transport-out passage side of the reversal passage is opened. In the joining portion, a sensor is provided to detect the head and tail ends of both paper which passes through the transport-in passage and paper which passes the transport-out passage.

Moreover, sheet sorting mechanisms are known in which for the purpose of reducing switching motion noise in a branching portion, a branch claw provided in the branching portion of a transport passage and a transport roller driving portion ahead of the branching portion are connected to each other by a driving force transmission mechanism, a torque limiter is provided in a part of the driving force transmission mechanism, and a direction of the branch claw is switched through selection of the rotation direction of a transfer roller.

### SUMMARY

According to one aspect of the present disclosure, an image forming apparatus includes an image forming section, a fixing portion, a discharging portion, a sheet transport passage, a reverse transport passage, a transport roller pair, a fixed guide portion, and a swingable guide portion, and has a double-sided printing function whereby a sheet is, starting with its tail end, guided into the reverse transport passage by the reverse rotation of the transport roller pair and then the sheet is, with its obverse and reverse sides reversed, transported again to the image forming section. The image forming section forms an image on a sheet. The fixing portion fuses the image formed by the image forming section on the sheet. The discharging portion discharges the sheet having the image fused thereto by the fixing portion. The sheet transport passage includes a curved portion, and connects between the fixing portion and the discharging portion. The reverse transport passage is formed by branching off the curved portion of the sheet transport passage, and is connected to an upstream-side part of the image forming section. The transport roller pair is provided in the sheet transport passage so as to be rotatable in normal and reverse directions; it, on one hand, transports the sheet transported from the fixing portion by the normal rotation toward the discharging portion and, on the other hand, transports, by switching back, the sheet to the discharging portion by the reverse rotation toward the reverse transport passage. The fixed guide portion is provided on the inner corner side of the curved portion of the sheet transport passage off which the reverse transport passage branches. The swingable guide portion is supported so as to be swingable in a direction protruding out of or retracting into the fixed guide portion. The swingable guide portion is arranged selectively either in a first position where the swingable guide portion protrudes farther into the sheet transport passage than a guide rib formed on the transport surface of the fixed guide portion or in a second position where the protruding height of the swingable guide portion from the transport surface is equal to the height of the guide rib or where the swingable guide portion is retracted farther toward the transport surface than the guide rib.

Further features and advantages of the present disclosure will become apparent from the description of embodiments given below.

### BRIEF DESCRIPTION OF THE DRAWINGS

FIG. 1 is a side sectional view showing an internal structure of an image forming apparatus 100 according to one embodiment of the present disclosure;

FIG. 2 is a partly enlarged view of and around a curved portion 20 in FIG. 1;

FIG. 3 is an exterior perspective view of a fixing portion 15;

FIG. 4 is an enlarged view of and around first transport guides 30a and 30b and a second transport guide 31b, with the first transport guides 30 arranged in a first position;

FIG. 5 is a side sectional view of first transport guides 30 located in a first position;

FIG. 6 is a side sectional view of first transport guides 30 located in a second position; and

FIG. 7 is an enlarged view of and around first transport guides 30a and 30b and a second transport guide 31b, with the first transport guides 30 arranged in a second position.

### DETAILED DESCRIPTION

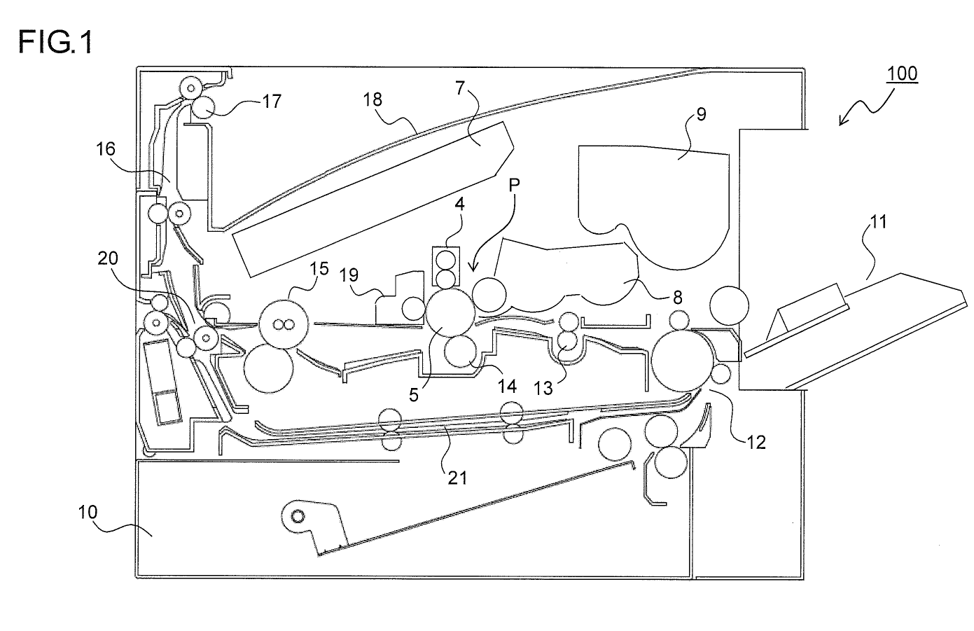

Hereinafter, embodiments of the present disclosure will be described with reference to the accompanying drawings. FIG. 1 is a side sectional view showing an internal structure of an image forming apparatus 100 according to one embodiment of the present disclosure. In the image forming apparatus (for example, a monochrome printer) 100, there is arranged an image forming section P that forms a monochrome image through the processes of electrostatic charging, exposure to light, image development, and image transfer. In the image forming section P, there are arranged, along the rotation direction (clockwise direction in FIG. 1) of a photosensitive drum 5, a charging unit 4, an exposure unit (such as a laser scanning unit) 7, a developing unit 8, a transfer roller 14, a cleaning device 19, and a static eliminator (unillustrated).

When an image forming operation is performed, the photosensitive drum 5 rotating in the clockwise direction is electrostatically charged uniformly by the charging unit 4, an electrostatic latent image is formed on the photosensitive drum 5 by a laser beam from the exposure unit 7 based on document image data, and developer (hereinafter referred to as toner) is attached to the electrostatic latent image by the developing unit 8 to form a toner image.

The toner is fed to the developing unit 8 from a toner container 9. The image data is transmitted from a personal computer (unillustrated) or the like. Moreover, the static eliminator (unillustrated) which removes residual electric charge on the surface of the photosensitive drum 5 is arranged on the downstream side of the cleaning device 19.

Toward the photosensitive drum 5 on which the toner image has been formed as described above, paper is transported through a paper transport passage 12 and a registration roller pair 13 from a paper feed cassette 10 or a manual paper feed device 11. Then, the toner image formed on the surface of the photosensitive drum 5 by the transfer roller 14 (an image transferring portion) is transferred to the paper. The paper to which the toner image has been transferred is separated from the photosensitive drum 5 and is transported to a fusing device 15, where the toner image is fused. The paper which has passed through the fusing device 15 is transported to an upper part of the apparatus through a paper transport passage 16. When an image is formed only on one side of paper (during single-sided printing), the paper is discharged onto a discharge tray 18 by a discharge roller pair 17.

On the other hand, when images are formed on both sides of paper (during double-sided printing), after the tail end of the paper has passed through a curved portion 20 of the paper transport passage 16, the transport direction is reversed. Thus, the paper is sorted to a reverse transport passage 21 which branches off the curved portion 20, and is transported again to the registration roller pair 13 with the image side reversed. Then, the next toner image formed on the photosensitive drum 5 is transferred to the side of the paper on which an image has not yet been formed by the transfer roller 14. The paper to which the toner image has been transferred is transported to the fusing device 15, where the toner image is fused, and is then discharged onto the discharge tray 18 by the discharge roller pair 17. A procedure for transporting paper during both-sided printing will be described in detail later.

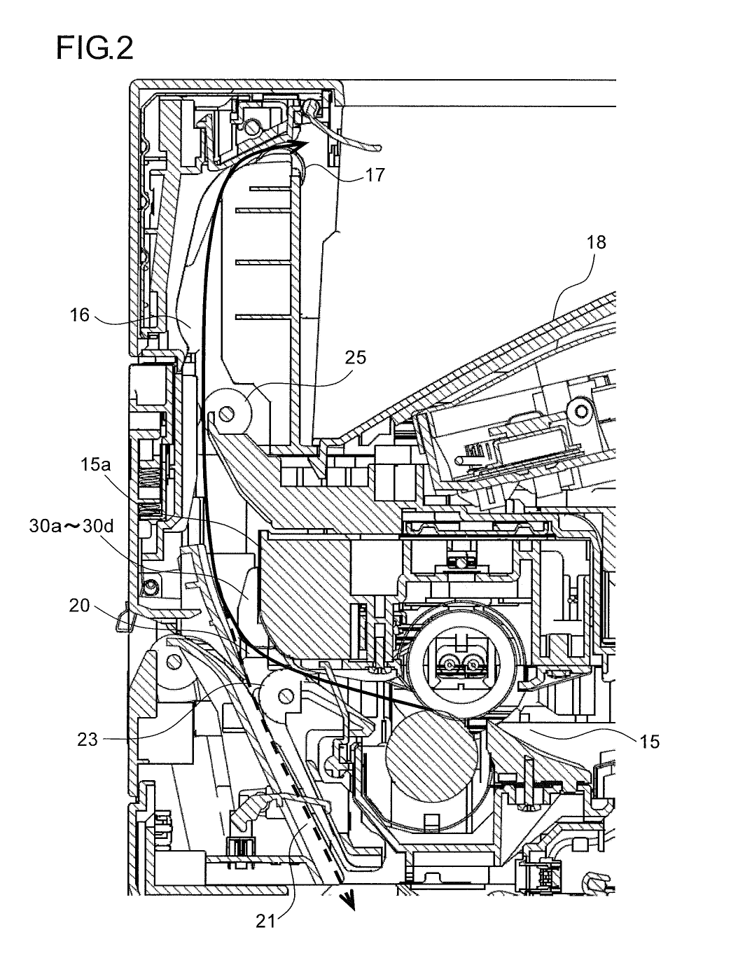

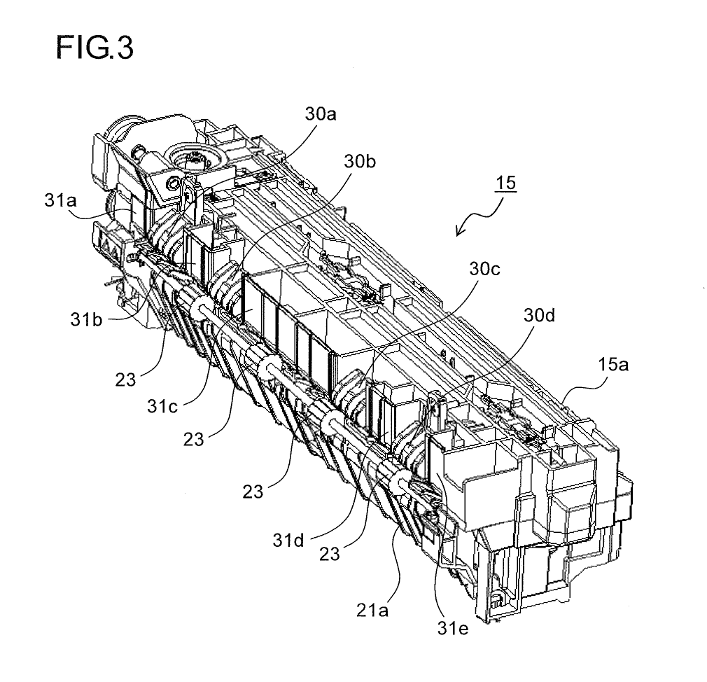

FIG. 2 is a partly enlarged view of and around the curved portion 20 in FIG. 1, and FIG. 3 is an exterior perspective view of the fusing device 15. As shown in FIG. 2, on the downstream side of the fusing device 15 with respect to the paper transport direction (the solid arrow in FIG. 2), the reverse transport passage 21 branches off the curved portion 20 of the paper transport passage 16. In the paper transport passage 16, transport roller pairs 23 and 25 are arranged between the fusing device 15 and the discharge roller pair 17. The paper which has passed through the fusing device 15 is transported via the transport roller pairs 23 and 25 to the discharge roller pair 17.

As shown in FIG. 3, a housing 15a of the fusing device 15 is provided with the transport roller pair 23 and first transport guides (swingable guides) 30. On the transport roller pair 23, four rollers fixed on a shaft are arranged at four positions of the housing 15a in its longitudinal direction (the paper width direction). The first transport guides 30 are arranged near the transport roller pair 23, on its downstream side with respect to the paper transport direction, at four positions of the housing 15a in its longitudinal direction. In FIG. 3, only one of the rollers composing the transport roller pair 23 is illustrated.

As shown in FIG. 2, the side surface, at one side (the front left side in FIG. 3), of the housing 15a forms a part of the transport surface of the curved portion 20 and the reverse transport passage 21. Specifically, the side surface above the transport roller pair 23 forms an inner corner-side transport surface 20a (second transport guides 31a to 31e) of the curved portion 20, and the side surface below the transport roller pair 23 forms a transport surface 21a of the reverse transport passage 21.

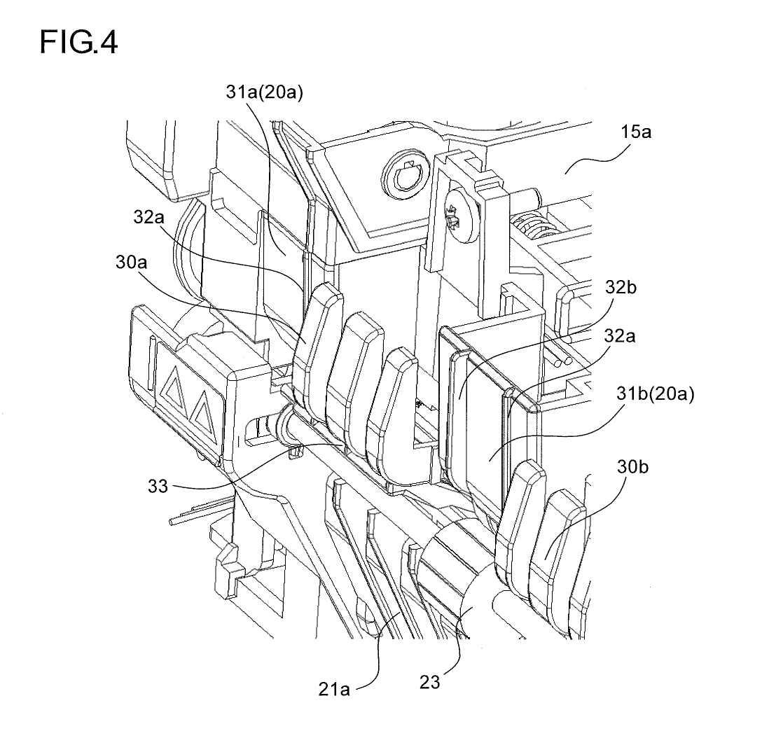

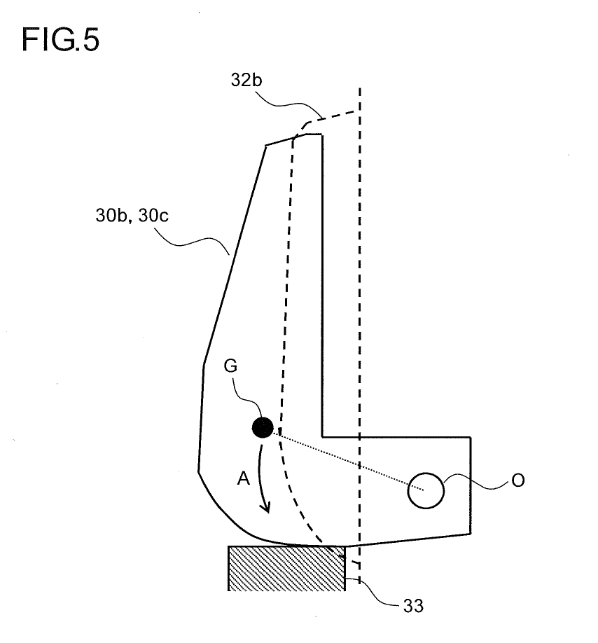

FIG. 4 is an enlarged view of and around the first transport guides 30a and 30b and the second transport guide 31b, and FIG. 5 is a side sectional view of the first transport guides 30a to 30d. The first transport guides 30 are arranged at four positions corresponding to both end parts of each of a large size (A3 and B4 size) and a small size (A4 and B5 portrait) in the paper width direction so as to protrude into the paper transport passage 16. One of the first transport guides 30 is composed of three guide claws arrayed in the paper width direction. As shown in FIG. 5, the claws are supported on the housing 15a so as to be swingable about a pivot O as a center. The first transport guides 30c and 30d and the second transport guide 31d have a structure symmetrical with that shown in FIG. 4, and therefore no overlapping description will be repeated.

The centers of gravity G of the first transport guides 30a to 30d are located farther outward of the housing 15a (leftward in FIG. 5) than the swingable fulcrum O is. Thus, the first transport guides 30a to 30d are acted on by a moment in the direction indicated by arrow A, and are ordinarily supported in an upright state as shown in FIG. 4 with the bottom end parts of the first transport guides 30a to 30d abutting on a support portion 33.

Moreover, the second transport guides 31a to 31e (fixed guides) are provided outward of and between the first transport guides 30a and 30d. The second transport guides 31a to 31e are each formed integrally with a transport rib 32a which extends in the paper transport direction (the up/down direction in FIG. 4). Moreover, the second transport guides 31b and 31d in the second position as counted from opposite sides with respect to the paper width direction are each formed integrally with a guide rib 32b with a larger protruding height than the transport rib 32a. The first transport guides 30 are, in an upright state as shown in FIG. 5, arranged at a position protruding farther into the curved portion 20 (hereinafter referred to as the first position) than the guide rib 32b.

The arrangement of the first transport guides 30a to 30d and the second transport guides 31a to 31e will be described in more detail. As shown in FIG. 3, the first transport guides 30a to 30d and the second transport guides 31a to 31e are arranged alternately in the paper width direction. Specifically, both end parts of A3 size paper in the width direction face the outermost second transport guides 31a and 31e respectively. Both end parts of B4 size paper in the width direction face the middle one of the three guide claws of the outer first transport guides 30a and 30d respectively. Both end parts of A5 portrait size paper in the width direction face the inner first transport guides 30b and 30c respectively.

Moreover, of the ribs formed on the second transport guides 31b and 31d in the second position as counted from opposite sides in FIG. 3, the outer ribs are the guide ribs 32b and are formed at positions that both end parts of A4 portrait size paper in the width direction face. Both end parts of B5 portrait size paper in the width direction face the transport ribs 32a formed inward of and next to the guide ribs 32b in the paper width direction on the second transport guides 31b and 31d.

Now, how the first transport guides 30a to 30d and the second transport guides 31a to 31e function when A4 portrait size paper passes through the curved portion 20 will be described. First, a description will be given of a case where plain paper is subjected to single-sided printing. In this case, plain paper to which a toner image formed on the photosensitive drum 5 (see FIG. 1) has been transferred by the transfer roller 14 (see FIG. 1) has the toner image fused in the fusing device 15.

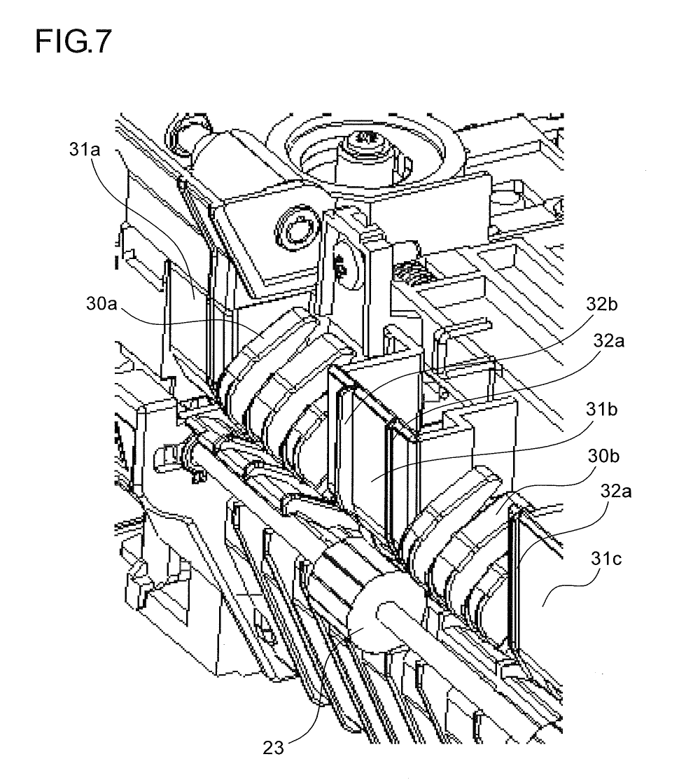

The plain paper which has passed through the fusing device 15 is transported upward (the solid arrow in FIG. 2) through the paper transport passage 16 by the transport roller pair 23. Here, the plain paper passes through the curved portion 20 while making contact with the first transport guides 30b and 30c. As described previously, the first transport guides 30b and 30c are swingable about the pivot O as a center. Thus, as shown in FIG. 7, the first transport guides 30b and 30c rotate in the clockwise direction (direction indicated by arrow A′) against the moment (see FIG. 5) acting on the first transport guides 30b and 30c resulting from the plain paper making contact with them. As a result, the first transport guides 30b and 30c are brought into a state inclined toward the transport surface 20a, and this helps reduce the transport load applied when the plain paper is guided upward. Then, the plain paper is discharged via the transport roller pair 25 and the discharge roller pair 17 onto the discharge tray 18, and thus single-sided printing is completed. After the passage of the plain paper, the first transport guides 30b and 30c return to the first position.

Next, in a case where plain paper is subjected to double-sided printing, the plain paper which has passed through the fusing device 15 is transported upward (the solid arrow in FIG. 2) through the paper transport passage 16 by the transport roller pairs 23 and 25 and the discharge roller pair 17. Then, at the time that the tail end of the plain paper has just passed through the curved portion 20 (with the tail end of the plain paper overlapping the first transport guides 30b and 30c) the transport roller pair 25 and discharge roller pair 17 are rotated in the opposite direction. This reverses the transport direction of the plain paper, and the plain paper, now starting with its tail end, passes downward through the curved portion 20 again. Then, the first transport guides 30b and 30c return to the first position by swinging, as if pushing back the plain paper, in the direction indicated by arrow A in FIG. 5. Thus, the tail end of the plain paper is guided to the reverse transport passage 21 along the first transport guides 30 (the broken-line arrow in FIG. 2).

The plain paper which has passed through the reverse transport passage 21 is transported again to the registration roller pair 13 (see FIG. 1) with the image side reversed. Then, the next tonner image formed on the photosensitive drum 5 is transferred to the side of the plain paper on which an image has not yet been formed by the transfer roller 14. The plain paper to which the toner image has been transferred is transported again to the fusing device 15, where the toner image is fused, and is then discharged onto the discharge tray 18 by the transport roller pairs 23 and 25 and the discharge roller pair 17, and thus double-sided printing is completed.

As described previously, during double-sided printing on plain paper, with the first transport guides 30b and 30c swingably provided in the curved portion 20, it is possible to guide the plain paper to the reverse transport passage 21 smoothly without applying a transport load to the plain paper.

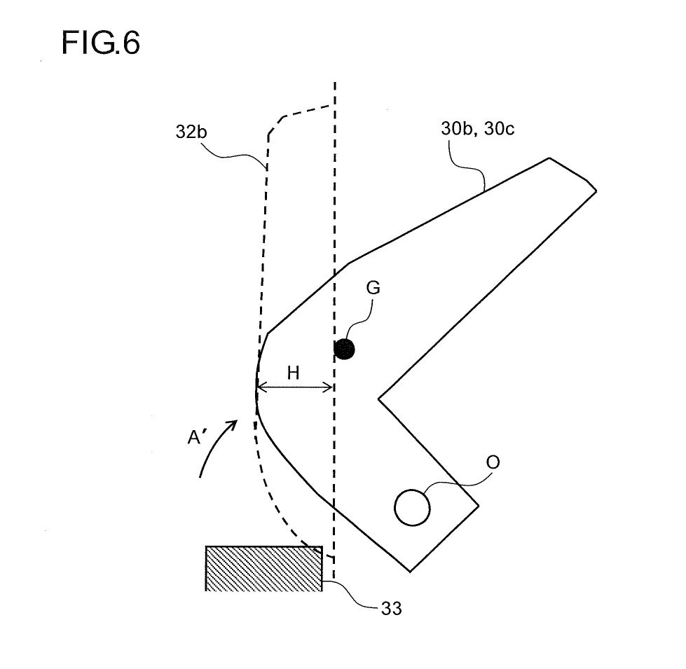

Now, a description will be given of a case where thick paper is subjected to single-sided printing. The thick paper which has passed through the fusing device 15 is transported upward (the solid arrow in FIG. 2) through the paper transport passage 16 by the transport roller pair 23. Then, as shown in FIG. 6, the first transport guides 30b and 30c are rotated in the clockwise direction (direction indicated by arrow A′) against the moment (see FIG. 5) acting on themselves.

As a result, as with the plain paper, as shown in FIG. 7, the first transport guides 30b and 30c are brought into a state inclined toward the transport surface 20a. As shown in FIG. 6, when in the inclined state, the first transport guides 30b and 30c are arranged in a position where their maximum protrusion height relative to the transport surface 20a is the same as the height of the guide rib 32b (hereinafter referred to as the second position). Specifically, at least upstream-side (upper in FIG. 6) parts of the first transport guides 30b and 30c are retracted from the guide rib 32b toward the transport surface 20a with respect to the paper transport direction from the paper transport passage 16 through the curved portion 20 to the reverse transport passage 21.

Then, as with the plain paper, the thick paper is discharged via the transport roller pair 25 and the discharge roller pair 17 onto the discharge tray 18, and thus single-sided printing is completed. After the passage of the thick paper, the first transport guides 30b and 30c return to the first position by their weight.

On the other hand, in a case where thick paper is subjected to double-sided printing, the thick paper which has passed through the fusing device 15 is transported upward through the paper transport passage 16 by the transport roller pairs 23 and 25 and the discharge roller pair 17 (the solid arrow in FIG. 2). Then, at the time that the tail end of the thick paper has just passed through the curved portion 20, the transport roller pair 25 and discharge roller pair 17 are rotated in the opposite direction. This reverses the transport direction of the thick paper, and the thick paper, now starting with its tail end, passes downward through the curved portion 20 again.

Here, the thick paper has been transported upward first, and has not yet completely passed through the first transport guides 30b and 30c; it thus has its tail end overlapping the first transport guides 30b and 30c. During double-sided printing on plain paper, which is pliable, the first transport guides 30b and 30c return to the first position as if pushing back the paper; however, with thick paper, which is less pliable than plain paper, the first transport guides 30b and 30c cannot return to the first position. Thus, the first transport guides 30b and 30c remain in the second position, where they cannot serve to guide the thick paper to the reverse transport passage 21.

As a solution, the second transport guides 31b is provided with the guide rib 32b such that the guide rib 32b protrudes farther from the transport surface 20a than the first transport guides 30b and 30c in the second position. This allows thick paper to pass through the curved portion 20 along the guide rib 32b and be guided to the reverse transport passage 21. Thereafter, the thick paper that has, as with plain paper, a toner image transferred and fused to the side on which an image has not yet been formed is discharged onto the discharge tray 18 by the transport roller pairs 23 and 25 and the discharge roller pair 17, and thus double-sided printing is completed.

In this embodiment, the second transport guides 31b and 31d are each provided with the guide rib 32b, and the first transport guides 30b and 30c are swingable between the first position protruding farther into the curved portion 20 than the guide rib 32b and the second position retracted farther from the curved portion 20 than the second guide 32b. With this configuration, during single- and double-sided printing on plain paper and during single-sided printing on thick paper, it is possible to guide the paper along the first transport guides 30b and 30c arranged in the first position to a predetermined transport passage smoothly without applying a transport load to the paper.

On the other hand, during double-sided printing on thick paper, instead of being guided by the first transport guides 30b and 30c which are inclined by the passage of the thick paper into the second position, the thick paper is guided smoothly to the reverse transport passage 21 along the guide rib 32b protruding into the curved portion 20. Thus, it is possible to prevent a jam resulting from the thick paper that has entered the curved portion 20 starting with its tail end being guided to the transport roller pair 23 (the paper transport passage 16).

Here, as shown in FIG. 6, the first transport guides 30b and 30c are configured such that their maximum protrusion height H is the same as the height of the guide rib 32b. This, however, is not meant as any limitation; the maximum protrusion height H of the first transport guides 30b and 30c may be less than the height of the guide rib 32b.

The embodiments described above are in no way meant to limit the present disclosure, which thus allows for many modifications and variations within the spirit of the present disclosure. For example, although in the above described embodiment, the first transport guides 30a to 30d are provided at four positions in the paper width direction, and the guide ribs 32b are provided at two positions in the paper width direction, the number and arrangement of the first transport guides 30 and the guide ribs 32b may be changed as necessary according to width of the paper used or the like.

Also, the magnitude of the moment that acts on the first transport guides 30a to 30d can be adjusted by adjusting the weight of the first transport guides 30a to 30d and the positional relationship between the swing pivot O and the center of gravity G according to the thickness and pliability of the paper used.

Needless to say, the present disclosure is applicable, not only to monochrome printers like the one shown in FIG. 1, but also to other types of image forming apparatus provided with a reverse transport passage for double-sided printing, such as color printers, monochrome and color copiers, digital multifunction peripherals, and facsimile machines.

The present disclosure is applicable to image forming apparatuses provided with a double-sided printing function for printing on both sides of a recording medium. Based on the present disclosure, it is possible to provide an image forming apparatus with a simple configuration that can guide paper, irrespective of its type, smoothly to a reverse transport passage and that can prevent a jam during double-sided printing.

What is claimed is:

1. An image forming apparatus comprising:
an image forming section forming an image on a sheet;
a fixing portion fusing the image formed by the image forming section on the sheet;
a discharging portion discharging the sheet having the image fused thereto by the fixing portion;
a sheet transport passage including a curved portion, the sheet transport passage connecting between the fixing portion and the discharging portion;
a reverse transport passage formed by branching off the curved portion of the sheet transport passage, the reverse transport passage being connected to an upstream-side part of the image forming section;
a transport roller pair provided in the sheet transport passage so as to be rotatable in normal and reverse directions, the transport roller pair transporting the sheet transported from the fixing portion by the normal rotation toward the discharging portion, the transport roller pair transporting, by switching back, the sheet transported to the discharging portion by the reverse rotation toward the reverse transport passage;
a fixed guide portion provided on an inner corner side of the curved portion of the sheet transport passage off which the reverse transport passage branches; and
a swingable guide portion supported so as to be swingable in a direction protruding out of or retracting into the fixed guide portion,
wherein
the image forming apparatus has a double-sided printing function whereby a sheet is, starting with a tail end thereof, guided into the reverse transport passage by the reverse rotation of the transport roller pair and then the sheet is, with obverse and reverse sides reversed, transported again to the image forming section, and
the swingable guide portion is arranged selectively either in a first position where the swingable guide protrudes farther into the sheet transport passage than a guide rib formed on a transport surface of the fixed guide portion or a second position where a protruding height of the swingable guide portion from the transport surface is equal to a height of the guide rib or where the swingable guide portion is retracted farther toward the transport surface than the guide rib.

2. The image forming apparatus of claim 1,
wherein without applying of an external force, the swingable guide portion is arranged in the first position so as to be movable to the second position when a sheet passes through the curved portion.

3. The image forming apparatus of claim 2,
wherein the swingable guide portion is arranged so as to occur a rotational moment that makes the swingable guide portion swing toward the first position, and
when a magnitude of an external force that acts on the swingable guide portion from a sheet passing through the curved portion exceeds a magnitude of the moment, the swingable guide portion moves to the second position.

4. The image forming apparatus of claim 3,
wherein the swingable guide portion moves from the first position to the second position by being contacted by a head end part of a sheet passing from the sheet transport passage via the curved portion toward the discharging portion,
when a tail end of the sheet passing toward the discharging portion is located in the curved portion, during double-sided printing in which the transport roller pair is rotated in a reverse direction so that the sheet is transported in an opposite direction to permit the sheet to be guided, starting with a tail end thereof, into the reverse transport passage and then transported, with obverse and reverse sides reversed, again to the image forming section,
in a case where the sheet has a predetermined thickness or less, the swingable guide portion swings from the second position to the first position against an external force acting on the swingable guide portion from the tail end part of the sheet, and the sheet is guided into the reverse transport passage along the first transport guide, and
in a case where the sheet has more than the predetermined thickness, the swingable guide portion is held in the second position by an external force acting on the first transport guide from the tail end part of the sheet, and the sheet is guided into the reverse transport passage along the guide rib.

5. The image forming apparatus of claim 1,
wherein when the swingable guide portion is located in the second position, at least an upstream-side part of the swingable guide portion in a reverse transport direction in which a sheet passes from the sheet transport passage through the curved portion toward the reverse transport passage is retracted farther toward the transport surface than the fixed guide portion.

6. The image forming apparatus of claim 1,
wherein the swingable guide portion comprises a plurality of swingable guides arranged one at each of a plurality of positions corresponding to both end parts of a plurality of sizes in a sheet width direction.

7. The image forming apparatus of claim 6,
wherein the fixed guide portion comprises a plurality of fixed guides arranged outward of each outermost one of the swingable guides in the sheet width direction and arranged between adjacent ones of the swingable guides in the sheet width direction.

8. The image forming apparatus of claim 7,
wherein the fixed guides have each formed thereon a transport rib which extends in the sheet transport direction, and at least one of the fixed guides has formed thereon, close to a swingable guide, the guide rib parallel to, and with a larger protruding height than, the transport rib.
